(19) United States
(12) Patent Application Publication
(10) Pub. No.: US 2007/0116865 A1
(43) Pub. Date: May 24, 2007

(54) Process and apparatus for highway marking

(76) Inventor: George Jay Lichtblau, Ridgefield, CT (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/285,276

(22) Filed: Nov. 22, 2005

(51) Int. Cl. B05D 5/10

(52) U.S. Cl. 427/136

(57) ABSTRACT

A process and apparatus for forming a coherent refractory mass on the surface of a road wherein one or more non-combustible materials are mixed with one or more metallic combustible powders and an oxidizer, igniting the mixture so that the combustible metallic particles react in an exothermic manner with the oxidizer and release sufficient heat to form a coherent mass under the action of the heat of combustion and projecting this mass against the surface of the road so that the mass adheres durably to the surface of the road. The combustion chamber can be operative with a reverse vortex to cool the walls of the chamber.

### CROSS REFERENCE TO RELATED APPLICATIONS

This application is related to U.S. patent application Ser. No. 10/863,651 filed Jun. 8, 2004, incorporated herein by reference and U.S. patent application No. ______, filed ______ (attorney docket GL-021DX).

### STATEMENT REGARDING FEDERALLY SPONSORED RESEARCH OR DEVELOPMENT

N/A

### BACKGROUND OF THE INVENTION

The methods of “painting” lines on highways or road markings have changed very little in the past thirty years. Herein the word “painting” refers to any method of applying a coating to a road surface to form a line or road marking. Prior to this invention, there were only three widely used methods to paint lines on highways. The most common technique is to spray a chemical paint on to the road and wait for the paint to dry. The apparatus to spray this paint is typically an “air” or “airless” paint machine wherein the paint is carried by air and projected to the road surface or where the paint the forced through a small hole at very high pressure and projected onto the road surface. The “chemical spray” is the most widely used system to paint lines on highways or road markings.

The second technique to paint lines on highways is to apply a tape to the road surface wherein this tape is bonded to the road surface either with heat or with suitable chemicals. U.S. Pat. No. 4,162,862 illustrates a “Pavement Striping Apparatus and Method” using a machine to press the tape into hot fresh asphalt. U.S. Pat. No. 4,236,950 illustrates another method of applying a multilayer road marking prefabricated tape material.

A third technique is to use a high velocity, oxygen fuel (“HVOF”) thermal spray gun to spray a melted power or ceramic powder onto a substrate. This is shown in U.S. Pat. No. 5,285,967.

Of the three painting methods, the first method of spraying a chemical onto the road surface and waiting for the paint to dry is the predominant technique used today.

The history of line painting indicates that there are at least three properties of “paint” which are important to the highway marking industry: (1) The speed at which the paint dries. (2) The bonding strength of the paint to the road surface. (3) The durability of the paint to withstand the action of automobiles, sand, rain, water, etc.

As discussed in U.S. Pat. No. 3,706,684 (Dec. 19, 1972), the first conventional traffic paints were based on drying oil alkyds to which a solvent, such as naphtha or white spirits was added. The paint dries as the solvent is released by evaporation. However, the paint “drying” (oxidation) process “continues and the film becomes progressively harder, resulting in embrittlement and reduction of abrasive resistance thereof causing the film to crack and peel off.” The above patent describes “rapid-dry, one-package, epoxy traffic paint compositions which require no curing agent.”

As described in U.S. Pat. No. 4,765,773:

“The road and highways of the country must be painted frequently with markings indicating dividing lines, turn lanes, cross walks and other safety signs. While these markings are usually applied in the form of fast drying paint, the paint does not dry instantly. Thus a portion of the road or highway must be blocked off for a time sufficient to allow the paint to dry. This, however, can lead to traffic congestion. If the road is not blocked for sufficient time to allow the paint to dry, vehicle traffic can smear the paint making it unsightly. Also in some instances the traffic will mar the marking to such an extent that the safety message is unclear, which could lead to accidents.”

Low-boiling volatile organic solvents evaporate rapidly after application of the paint on the road to provide the desired fast drying characteristics of a freshly applied road marking.

The U.S. Pat. No. 4,765,773 illustrates the use of microwave energy to hasten the paint drying process of such solvents.

While the low-boiling volatile organic solvents promote rapid drying, “this type of paint formulation tends to expose the workers to the vapors of the organic solvents. Because of these shortcomings and increasingly stringent environmental mandates from governments and communities, it is highly desirable to develop more environmentally friendly coatings or paints while retaining fast drying properties and/or characteristics” (U.S. Pat. No. 6,475,556).

To solve this problem paints have been developed using waterborne rather than solvent based polymers or resins. U.S. Pat. No. 6,337,106 describes a method of producing a fast-setting waterborne paint. However, the drying times of waterborne paints are generally longer than those exhibited by the organic solvent based coatings. In addition the waterborne paints are severely limited by the weather and atmospheric conditions at the time of application. Typically the paint cannot be applied when the road surface is wet or when the temperature is below −10° centigrade. Also, the drying time strongly depends upon the relative humidity of the atmosphere in which the paint is applied. A waterborne paint may take several hours or more to dry in high humidity. Lastly the waterborne paints, which are generally known as “rubber based paints”, are made from aqueous dispersion polymers. These polymers are generally very “soft” and abrade easily from the road surface due to vehicular traffic, sand and weather erosion.

The above patents all attempt to solve the paint drying problem when using “waterborne” paints and speeding the drying process. The present invention solves the drying problem by not using any solvents in the “painting process”.

The present invention relates closely to the work done to repair coke ovens, glass furnaces, soaking pots, reheat furnaces and the like which are lined with refractory brick or castings. This process is known today as “ceramic welding”.

U.S. Pat. No. 3,800,983 describes a process for forming a refractory mass by projecting at least one oxidizable substance which burns by combining with oxygen with accompanying evolution of heat and another non-combustible substance which is melted or partially melted by the heat of combustion and projected against the refractory brick. The invention is designed to repair, in situ, the lining of a furnace while the furnace is operating. Typically the temperature of the walls of the furnace is over 1500° centigrade and the projected powder(s) ignites spontaneously when projected against the hot surface. In this process it is extremely important that both the oxidizable and non-combustible particles are matched chemically and thermally with the lining of the furnace.

If the thermal properties are not correct, the new refractory mass will crack off from the lining of the furnace due to the differential expansion of the materials. If the chemical composition is not correct, the new refractory mass will “poison” the melt in the furnace.

In the U.S. Pat. No. 3,800,983 the oxidizable and non-oxidizable particles are combined as one powdered mixture. The powder is then aspirated from the powder hopper by using pure oxygen under pressure. The resulting powder-oxygen mixture is then driven through a flexible supply line to a water-cooled lance. The lance is used to project the powder-oxygen mixture against the refractory lining of the furnace to be repaired. The powder-oxygen mixture ignites spontaneously when it impinges on the hot surface of the oven.

The object of the '983 invention and those that followed is to select the composition of the powders to match the characteristics of the refractory lining and to prevent “flashback” up the lance and back towards the operator of the equipment. “Flashback” is the process wherein the oxygen-powder stream burns so quickly that the flame travels in the reverse direction from the oxygen-powder and causes damage to the equipment and serious hazards to the equipment operator.

U.S. Pat. No. 4,792,468 describes a process similar to that above and specifically illustrates the chemical and physical properties of the oxidizable and refractory particles needed to form a substantially crack-free refractory mass on the refractory lining.

U.S. Pat. No. 4,946,806 describes a process based upon the U.S. Pat. No. 3,800,893 wherein the invention provides for the use of zinc metal powder or magnesium metal powder or a mixture of the two as the heat sources in the formation of the refractory mass.

U.S. Pat. No. 5,013,499 describes a method of flame spraying refractory materials (now called “ceramic welding”) for in situ repair of furnace linings wherein pure oxygen is used as the aspirating gas and also the accelerating gas and the highly combustible materials can be chromium, aluminum, zirconium or magnesium without flashback. The apparatus is capable of very high deposition rates of material.

U.S. Pat. No. 5,002,805 improves on the chemical composition of the oxidizable and non-oxidizable powders by adding a “fluxing agent” to the mixture.

U.S. Pat. No. 5,202,090 describes an apparatus similar to that shown in U.S. Pat. No. 5,013,499. In the '090 patent, there are specific details about the mechanical equipment used to mix the powdered material with oxygen and transport the oxygen-powder combination to the lance. This apparatus also permits very high deposition rates of the refractory material without flashback.

U.S. Pat. No. 5,401,698 describes an improved “Ceramic Welding Powder Mixture” for use in the apparatus shown in the previous patents listed. This mixture requires that at least two metals are used as fuel powder and the refractory powder contains at least magnesia, alumina or chromic oxide.

U.S. Pat. No. 5,686,028 describes a ceramic welding process where the refractory powder is comprised of at least one silicon compound and also that the non-metallic precursor is selected from either CaO, MgO or FeO.

U.S. Pat. No. 5,866,049 is a further improvement on the composition of the ceramic welding powder described in U.S. Pat. No. 5,686,028.

U.S. Pat. No. 6,372,288 is a further improvement on the composition of the ceramic welding powder wherein the powder contains at least one substance which enhances production of a vitreous phase in the refractory mass.

### BRIEF SUMMARY OF THE INVENTION

The invention provides a method of and apparatus for flame spraying refractory material directly onto a road surface to provide a highly reflective, very durable and instant drying “paint” to said road surface. Since the paint contains no solvents and the flame spraying process operates at very high temperatures, the “paint” can be applied under widely varying conditions of temperature and humidity.

The present invention makes use of a ceramic welding process in which one or more non-combustible ceramic powders are mixed with a metallic fuel and an oxidizer. The mixture is transported to a combustion chamber, ignited and projected against the surface of the road. Alternately, the constituents can be mixed in the combustion chamber. The fuel is typically aluminum or silicon powder and the non-combustible ceramic powder is typically silicon dioxide, titanium dioxide or mixtures thereof or other oxides described below. The oxidizer is typically a chemical powder, but can also be pure oxygen or air. The heat of combustion melts or partially melts the ceramic powder forming a coherent mass that is projected against the road surface, the temperature of the materials causing the coherent mass to adhere durably to the surface.

In another aspect of the invention a metallic powder of silicon or aluminum is combusted in a combustion chamber to melt a mixture of silicon dioxide (SiO₂), calcium oxide (CaO) and sodium carbonate (NA₂CO₃) to produce a soda-lime glass (NA₂SI₂O₅). The material resulting from the combustion is a slurry of liquid soda-lime and crystalline silicon dioxide and CaSiO₃ or Ca₂SiO₄ in crystalline form. This glass-like composition melts at a temperature of about 1280° Kelvin (1007° C. or 1845° F.) which is much lower than the temperature needed to melt silicon dioxide.

Iron powder can be employed as the metallic fuel and during the combustion process forms Fe₂O₃ which is yellow in color and which can serve as the yellow pigment for road marking.

The combustion chamber can be embodied as a reverse vortex flow chamber in which a reverse vortex provides a thermal insulating layer of gas along the walls of the chamber to prevent the high temperatures of combustion from melting or otherwise damaging the chamber walls.

The object of the present invention is to present a method of “painting” lines on roads, wherein the “paint” dries instantly, adheres durably to the road, has extreme resistance to abrasion and erosion, wind, sand and rain, and is inherently safe from “flashback”. This “paint” can be applied at any temperature and under wet and rainy conditions. The operating temperature of the combustion chamber is typically on the order of 2000° Kelvin (3632° F.) or above.

### BRIEF DESCRIPTION OF THE SEVERAL VIEWS OF THE DRAWINGS

The invention will be more fully described in the following detailed description taken in conjunction with the drawings in which:

FIG. 1 is a diagrammatic representation of apparatus in accordance with the invention;

FIG. 2 is a diagrammatic representation of an alternative embodiment of the apparatus according to the invention;

FIG. 3 is a diagrammatic representation of a further embodiment of the apparatus according to the invention;

FIG. 4 is a diagrammatic representation of one embodiment of a combustion chamber employed in the invention;

FIG. 5 is a diagrammatic representation of a frustrum-shaped reverse vortex combustion chamber employed in the invention;

FIG. 6 is a cross-sectional view of one embodiment of a multiple nozzle arrangement used in the combustion chamber of FIG. 5;

FIG. 7 is a diagrammatic representation of a cylindrical-shaped combustion chamber employed in the invention.

FIG. 8 is a diagrammatic view of an alternative version of the combustion chamber;

FIG. 9 shows a variation in the combustion chamber of FIG. 8;

FIG. 10 shows a further embodiment of a combustion chamber having a double vessel construction;

FIG. 11 is a cross-sectional view of the embodiment of FIG. 10; and

FIG. 12 shows a screw feeder employed in the invention.

### DETAILED DESCRIPTION OF THE INVENTION

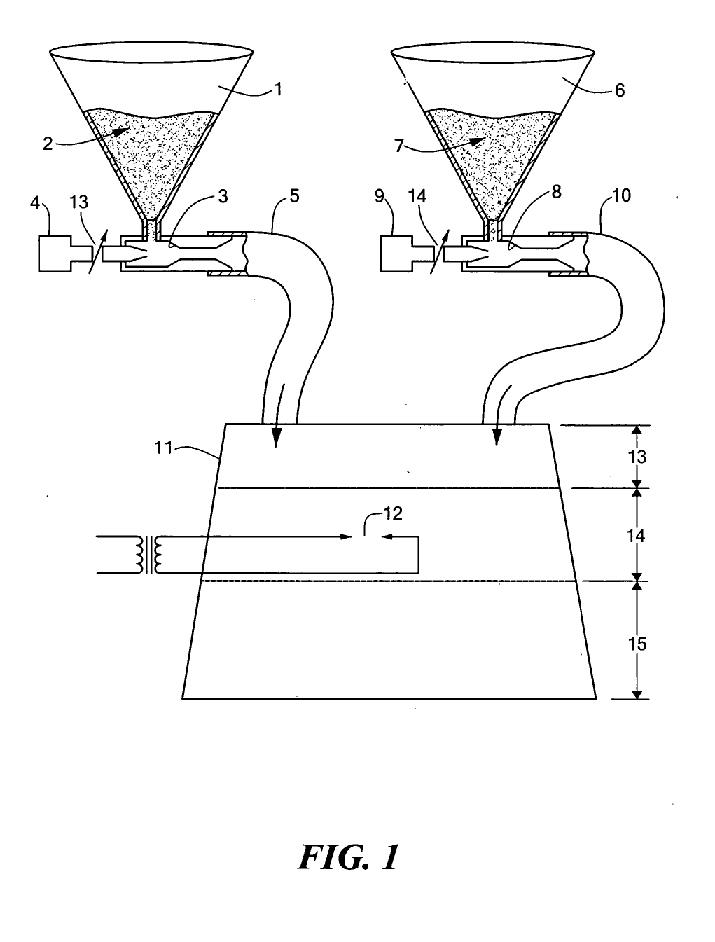

FIG. 1 illustrates a typical embodiment of apparatus employed in this invention. Hopper (1) contains the metallic fuel powder (2) typically aluminum powder or silicon powder. Other suitable combustible powders include zinc, magnesium, zirconium, iron and chromium. Mixtures of two or more combustible powders can also be used. Hopper (6) contains the powdered chemical oxidizer (7), typically ammonium nitrate, potassium nitrate or sodium nitrate. The non-combustible ceramic material, typically silicon dioxide, titanium dioxide or powdered or ground glass, can be combined with the fuel powder, the chemical oxidizer or both. Each hopper feeds the powder by gravity into a venturi (3 and 8) fed by air or oxygen (4 and 9). The gas flowing through the venturi is controlled by valves (13) or (14) and aspirates the powder into the air stream. The air streams from both hoppers travel in separate supply lines (5) and (10) and combine in the combustion chamber (11) where the airstreams are mixed and ignited, typically by an electric arc (12) or gas fed pilot light or plasma arc. The resulting combustion melts at least the surface of the non-combustible materials and the air streams project the melted material onto the road surface. The materials form a coherent ceramic or refractory mass that adheres durably to the surface of the road.

In FIG. 1 each hopper has its own supply line (5 and 10) and each supply line goes directly to the top portion of the combustion chamber (11). The combustion chamber has three areas of interest: The top portion (23) is where the metallic fuel and oxidizer mix; the middle portion (24) is where the fuel is ignited and high temperature burning takes place; and the lower portion (25) is the lowest temperature portion of the combustion chamber where secondary combustion effects take place.

In FIG. 1, the oxidizer may be pure oxygen supplied from a source (9) and controlled by variable valve (14). The oxygen goes via supply line (10) directly to the combustion chamber (11). In this case no powdered oxidizer is required and the second hopper (6) is not required. It is important that only air be used to aspirate the powdered fuel (2) from the hopper to the combustion chamber (11). The use of air to aspirate the fuel eliminates the possibility of “flashback” to the powdered fuel.

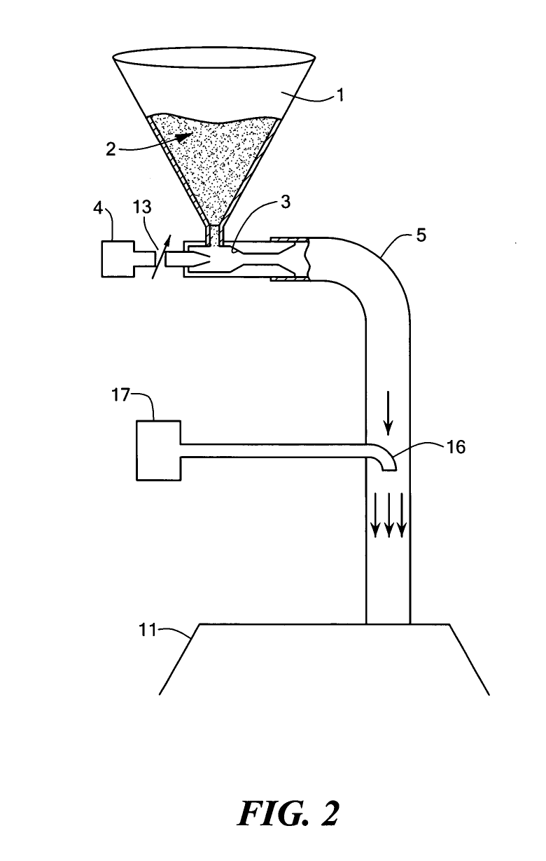

FIG. 2 illustrates another method of injecting pure oxygen into the combustion chamber. In this illustration, the powdered fuel is aspirated into the supply line (5) and driven towards the combustion chamber (11). At a point in the supply line (6) that is close to the combustion chamber, a supply of oxygen is injected into the supply line at point 16 from a source of oxygen (17). This oxygen accelerates the fuel-air mixture and supplies the oxygen necessary for combustion. The injection of oxygen close to the combustion chamber prevents “flashback” since the fuel is aspirated with air up to point number 16. Air is insufficient to maintain combustion of the powdered fuel. Therefore, the powdered fuel-air mixture cannot burn in the reverse direction towards the hopper (1). By injecting the oxygen into the supply line (6), the oxygen aides in the acceleration of the fuel and ceramic powder mixture towards the road surface and also promotes better mixing of the powdered fuel with the oxygen.

This process is inherently safe from “backflash” because the typical aluminum-powdered or silicon-powdered fuel is transported by air and is separated from the chemical oxidizer until the chemicals are combined in the combustion chamber (11). It is almost impossible to cause aluminum or silicon powder to backflash when transported by plain air. In addition, the oxidizer does not burn (or burns very slowly) in air thus preventing any backflash in the supply line (10) transporting the chemical oxidizer.

Another safety feature is that aluminum or silicon powder is very difficult to ignite in air. While there are many cautions regarding the use of aluminum powder, the aluminum powder cannot ignite in air unless the flame temperature (from a match etc) exceeds the melting temperature of aluminum oxide (2313 K). This inventor has run experiments with several particle sizes of aluminum powder; i.e. 1 micron up to 100 microns and has been unable to ignite any of the powders using a propane torch.

In addition, the non-combustible ceramic powder may be mixed with the metallic combustible powder or the powdered oxidizer. If the non-combustible powder is mixed with the powdered fuel, it will dilute the concentration of the powdered fuel and minimize the possibility of flashback or accidental ignition of the fuel. According to the various ceramic welding patent disclosures, the quantity of the powdered fuel will typically be less than 15% by weight of the non-combustible ceramic powder.

In other cases, air alone, without supplemental pure oxygen, is sufficient to supply the oxygen needed for combustion. In this case, air can be injected at point 16 of FIG. 2 to accelerate the mixture toward the surface and promote better mixing of the powdered fuel with the air.

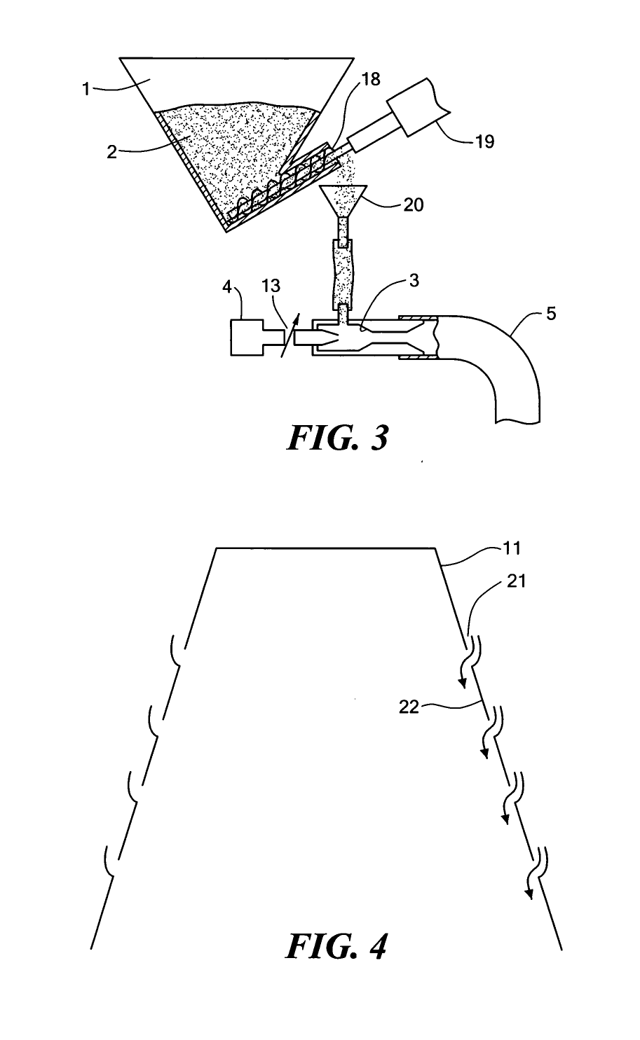

FIG. 3 illustrates in greater detail the apparatus used in this invention. The hopper (1) contains either the powdered fuel (2) or the powdered oxidizer (7). The powders are fed by a screw conveyer (18) which is driven by a variable speed motor (19). The screw conveyor feeds into a funnel (20) which is in fluid communication with an aspirator (3) into which a stream of air from source (4) is directed. The rate of flow of the air stream is controlled by valve (13) in series with the air source (4). The venturi aspirates the powdered fuel from the funnel into the supply line (5) wherein the entrained particles are delivered to the combustion chamber (11). The rate of deposition of the coherent mass onto the surface can be controlled by the rate of movement between the surface and the exit of the combustion chamber. The variable speed motor along with the screw conveyor and the air control valve (13) provide an accurate means of dispensing the powdered fuel(s) and oxidizer to the combustion chamber and varying the rate of combustion and deposition of the refractory materials onto the road surface. The variable speed motor and air control valve (13) are controlled by a device which measures the speed of the “line painting machine” relative to the surface of the road. In this manner the thickness of the deposition on the road surface can be controlled independently of the speed of the line painting apparatus relative to the surface of the road. The surface may be preheated prior to projecting the refractory mass thereon.

The choice of oxidizing chemical is very important to the safety and economics of this line painting process. The oxidizing chemical must be low cost, readily available, non-toxic, and burn with a flame temperature sufficiently high to soften or melt the ceramic materials used in this process. The following chemicals were considered:

Ammonium Perchlorate (NH4CLO4)

Ammonium Nitrate (NH4NO3)

Potassium Nitrate (KNO3)

Sodium Nitrate (NaNO3)

Potassium Perchlorate (KCLO4)

Sodium Perchlorate (NaCLO4)

Potassium Chlorate (KCLO3)

Sodium Chlorate (NaCLO3)

Air

Pure oxygen

Ammonium perchlorate is a well known and well characterized oxidizer used in solid state rocket fuels. It is the oxidizer for the solid rocket boosters for the space shuttle. It is relatively expensive and made by only one company in the United States. The combustion products are primarily NO and a small amount of NO₂, chlorine and hydrogen chloride (HCL), all of which are toxic. Therefore, ammonium perchlorate was ruled out for use as the oxidizer in this application.

Ammonium nitrate (NH₄NO₃) is one of the better oxidizers because it contains no chlorine and therefore produces no HCL. It may generate toxic amounts of NO, although the concentration of the NO when combined with free air is likely to be very low. Ammonium nitrate is also known as fertilizer and widely used in explosives. It is widely available and inexpensive. However, it takes 4.45 pounds of ammonium nitrate to burn one pound of aluminum and therefore ammonium nitrate will require larger volumes and weight than other potential oxidizers.

Potassium nitrate (KNO₃) and sodium nitrate (NaNO₃) are widely available, very inexpensive and will also generate a toxic amount of NO. Again, it is expected that the NO will be very much diluted with free air in the operation of this machine. Both potassium nitrate and sodium nitrate will generate byproducts which will react with air to create hydroxides. These hydroxides are soluble in water and may (or may not) cause problems with the deposition and adherence of the refractory material on the road surface. Only 2.25 pounds of KNO₃ are required to burn one pound of aluminum. Therefore, KNO₃ is a very good candidate for the oxidizer.

Sodium nitrate (NaNO₃) has very similar properties to KNO₃. It is readily available, low cost and only requires 1.89 pounds of KNO₃ to burn one pound of aluminum.

The other perchlorates and chlorates are similar in performance and combustion properties to sodium and potassium nitrate and will also generate byproducts that are water soluble. They are more expensive and less available than sodium and potassium nitrate.

Air is a very good candidate for use as the oxidizer. Obviously it is readily available and only requires a compressor. The question is can sufficient air be injected into the system to supply sufficient oxygen for the combustion and also not drain too much of the heat away.

Pure oxygen is an excellent candidate for the oxidizer. Using pure oxygen would create a process very similar to ceramic welding. There are no toxic byproducts and the valves and controls are inexpensive. Pure oxygen is very inexpensive and readily available. If compressed oxygen (as a gas) is used, the containers are very large and heavy relative to the amount of oxygen stored. Also, the problem of “flashback” must be addressed.

Liquid oxygen is a very good candidate for large volume highway painting applications. It is very inexpensive and widely available. The only problem is the storage and handling of the LOX.

The following non-combustible ceramic materials were considered for use as the “paint pigment” in this apparatus:

Silicon Dioxide

Titanium Dioxide

Aluminum Oxide

Chromium Oxide produced from refused grain brick.

Magnesium Oxide

Iron Oxide

Crushed colored glass

Magnesite regenerate

Corhart-Zac

Al₂O₃-/Bauxite-Regenerate

The prime criteria for the selection of the “paint pigment” are cost and availability. Titanium dioxide is the prime pigment used in white paints, is readily available, and is very low in cost. Aluminum oxide is also readily available, but is much more costly than titanium dioxide. Silicon dioxide is normally known as “sand” and may be the least expensive of all of the “paint pigments”. Chromium oxide, if produced from refused grain brick, is also a low cost ceramic material, but may not be consistent in its mixture. Refused grain brick is available commercially as, for example, Cohart RFG or Cohart 104 Grades. Magnesium oxide may be used in small amount to enhance the thermal properties of the final paint product. Magnesite regenerate, corhart-zac and bauxite-regenerate are recycled refractory products that were previously used in high temperature furnaces. A mixture of two or more non-combustible ceramic materials can be used.

In one embodiment, at least two non-combustible materials are mixed with at last one metallic combustible powder and an oxidizer. One of the non-combustible materials has a melting point in excess of the flame temperature of the burning metallic powder and oxidizer, and the second non-combustible material has a melting point that is lower than the flame temperature of the burning metallic powder and the oxidizer. The mixture is ignited so that the combustible particles react in an exothermic manner with the oxidizer and release sufficient heat to melt the lower melting point non-combustible material but not sufficient to melt the higher melting point non-combustible material. The materials are then projected onto the surface, and the lower melting point non-combustible material acts as a glue for the higher melting point non-combustible material and the products of combustion, and the resulting mass adheres durably to the surface. Preferably, the higher melting point non-combustible material includes titanium dioxide, aluminum oxide, magnesium oxide, chromium oxide, iron oxide, zirconium oxide, tungsten oxide or a mixture of two or more of these. The lower temperature non-combustible material is silicon dioxide or crushed glass (glass frit) and the metallic combustible powder is silicon or aluminum.

Some line painting compositions that are suitable for coating a road surface include a composition comprising titanium dioxide and silicon; a composition comprising titanium dioxide, silicon dioxide, and silicon; a composition comprising aluminum oxide and silicon; a composition comprising aluminum oxide, silicon dioxide, and silicon; a composition comprising iron oxide and silicon; a composition comprising iron oxide, silicon dioxide, and silicon; a composition comprising magnesium oxide and silicon; and a composition comprising magnesium oxide, silicon dioxide, and silicon. In some instances a small amount of aluminum can be employed to facilitate the ignition of the mixture in the combustion chamber.

A glass-like line painting composition can alternatively be employed. A presently preferred composition comprises silicon oxide (SiO₂) calcium oxide (CaO) and sodium carbonate (NA₂CO₃). The metallic fuel can typically be silicon or aluminum powder. Titanium oxide (TiO₂) can be utilized as a pigment to form a white marking composition. Air is employed as the preferred oxidizer. The heat of combustion forms a soda-lime glass as a liquid and a slurry of silicon dioxide and titanium oxide in crystalline form. The combustion temperature is about 1000° C. which is substantially less than the combustion temperature needed for melting silicon dioxide in the above described line painting compositions comprising one or more ceramic materials.

The ceramic compositions described above are primarily composed of silicon dioxide (sand) mixed with a pigment such as titanium dioxide for white lines or crushed yellow glass for yellow lines. The pigment normally is about 10% of the silicon dioxide content in the mixture. Sufficient heat must be supplied to melt the silicon dioxide and form a slurry with the pigment. The resulting slurry is projected from the combustion chamber onto the surface of the road for adherence durably thereon. Silicon dioxide melts at approximately 1900-2000° Kelvin (1727° C. or 3141° F.). This very high temperature can cause difficulty in the design of the combustion chamber and the selection of pigments to generate the intended color. For example, yellow iron oxide decomposes at a temperature several hundred degrees less than the melting temperature of silicon dioxide. Therefore, yellow iron oxide cannot be used as a pigment to generate the yellow color if the prime product of the combustion process is liquid silicon dioxide.

Glass-like materials can be employed in accordance with the invention which can be melted at much lower temperatures. As an example, silicon dioxide (SiO₂), calcium oxide (CaO) and sodium carbonate (Na₂CO₃) can be combined and heated by burning a metallic powder such as silicon or aluminum to create a soda-lime glass (Na₂Si₂O₅) as a liquid which melts at a temperature about 1280° Kelvin (1007° C. or 1845° F.). The resultant composition is a slurry of liquid soda-lime glass with crystalline silicon dioxide and either CaSi₃ or CA₂SiO₄ in crystalline form. A glass slurry can be created at about one-half of the temperature required to melt silicon dioxide. The glass slurry acts as a “glue” to hold the silicon dioxide and other solid particles to the highway surface and improves the adherence of the paint on the highway surface.

Titanium oxide can be utilized as a pigment to form a white marking composition. Iron can be employed as the combustible metallic powder which when burned forms yellow iron oxide (Fe₂O₃) which serves as the yellow pigment for yellow highway marking lines. Other pigments can be employed as described below.

The glass type compositions work well on highways covered with asphalt. The lower temperature glass compositions may not adhere well to concrete which melts at about the same temperature as silicon dioxide.

In addition to the selection of low cost ceramic or other materials for use as “paint pigment”, there is a requirement for coloring materials to produce the colors of yellow, blue and red on road surfaces. These coloring materials may be pre-mixed with the ceramic powder or powdered fuel, or may be added to the combustion chamber via a separate supply line. The coloring material can be, for example, tungsten, zirconium, crushed yellow or another color glass, or ferric oxide (Fe₂O₃). Similarly, retro-reflective beads can be added.

Since the oxidizer powders tend to be hygroscopic, it is necessary to add “anti-caking” agents to the powder to prevent the formation of clumps, which inhibits the powder from flowing smoothly. The “anti-caking” agent is also known as a “flow” agent. The typical flow agent is TCP (tri-calcium phosphate), although others are well known in the art.

FIG. 4 illustrates one aspect of the combustion chamber (11). Since the apparatus operates at extremely high temperature, typically at or above 2000° Kelvin, it is important that the combustion chamber be designed to be low cost and have a very long life at elevated temperature. The combustion chamber may be made of a suitable ceramic material, metal or a metal that is coated on the inside with a high temperature ceramic coating. FIG. 4 illustrates the use of small venturies (21) built into the sides of the combustion chamber. As the combustion products are projected from the combustion chamber (11), the velocity of the combustion gases create a partial vacuum on the inside surface of the combustion chamber. Cooler air is sucked into the venturi entrance (21) and flows along the inside of the combustion chamber (22). This air both cools the inside surface of the combustion chamber and also reduces the build up of residual products on the inside of the combustion chamber.

Because of the very high temperatures involved in the flame spray operation, typically 2000° C. and higher, it is very important to insulate the walls of the combustion chamber from the combustion process inside of the combustion chamber. One very effective method of doing this is to create a “reverse vortex” air flow inside of the combustion chamber.

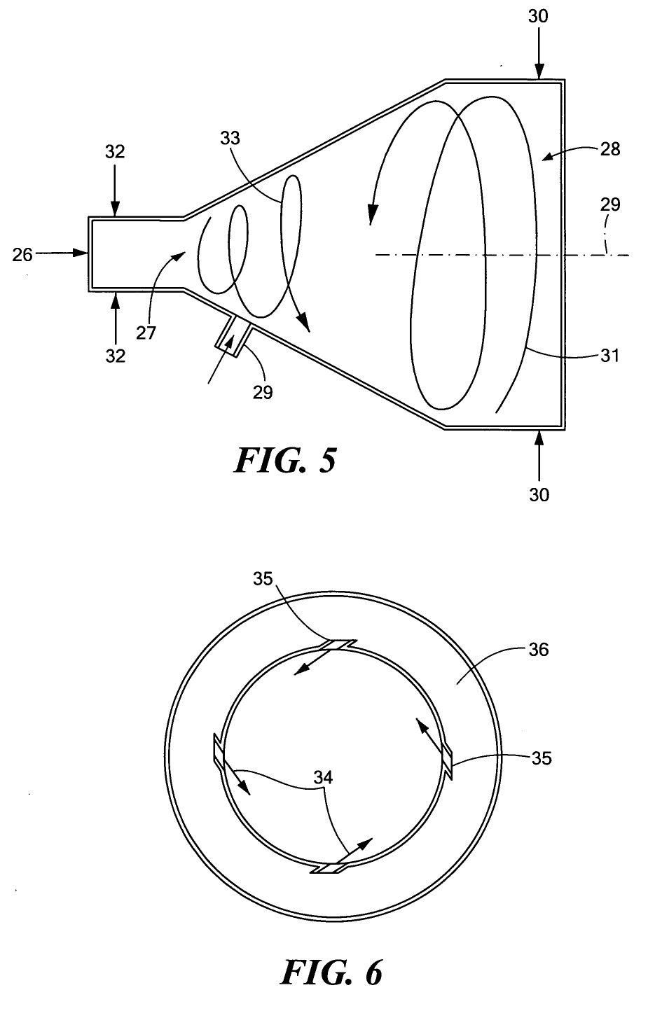

FIG. 5 illustrates one form of a reverse vortex combustion chamber. The combustion chamber is shaped as a frustum, which is a cone cut off at the narrow end. The narrow portion of the frustum (27) is the entrance or closed end of the combustion chamber and the wider portion (28) is the exit or open end of the combustion chamber. An exit aperture is typically provided at the open end and from which the flame spray is emitted. The powdered fuel/ceramic mixture is injected at (26) into the closed end of the combustion chamber as shown, and along the axis (29) of the chamber. The igniter (29) can be positioned on the side of the combustion chamber or along the same axis (29) as the fuel injection point. The gas carrier (typically air) of the powdered mixture causes an axial flow from the closed end to the open end of the combustion chamber. As an alternative, a portion of the powdered fuel/ceramic mixture can be introduced into the chamber along with air injected for the reverse vortex, such as at points (30).

Air is injected tangentially at one or more points (30) near the open end of the combustion chamber. This produces a gas flow (31) tangential to the walls of the frustum. The air flows relatively slowly from the open end to the closed end of the combustion chamber. Since the tangential air flow travels from the open end to the closed end of the combustion chamber, it is called a “reverse” vortex. It has been shown that a reverse vortex acts as an extremely good thermal insulator preventing the high temperature combustion along the axis of the combustion chamber from melting the walls of the combustion chamber, (See “Thermal Insulation of Plasma in Reverse Vortex Flow” by Dr. A. Gutsol, Institute of Chemistry and Technology, Kola Science Centre of the Russian Academy of Sciences) (Also see published application WO 2005/004556). Optionally, a second tangential gas flow may be introduced at one or more points (32) near the closed end of the combustion chamber. The tangential gas flow is directed so that the direction of rotation about the axis of the combustion chamber is in the same direction (33) as that produced by the air injected at point(s) (30). This second tangential gas injector promotes a faster reverse vortex and promotes better mixing of the fuel/air mixture.

FIG. 6 depicts a cross-sectional view of a multiple nozzle arrangement, wherein gas enters the combustion chamber tangentially at (34) through four nozzles (35) coupled to a plenum (36), thereby creating a gas flow tangential to the wall of the exit of the combustion chamber. This creates a vortex gas flow which gradually moves from the open end to the closed end of the combustion chamber with a strong circumferential velocity component.

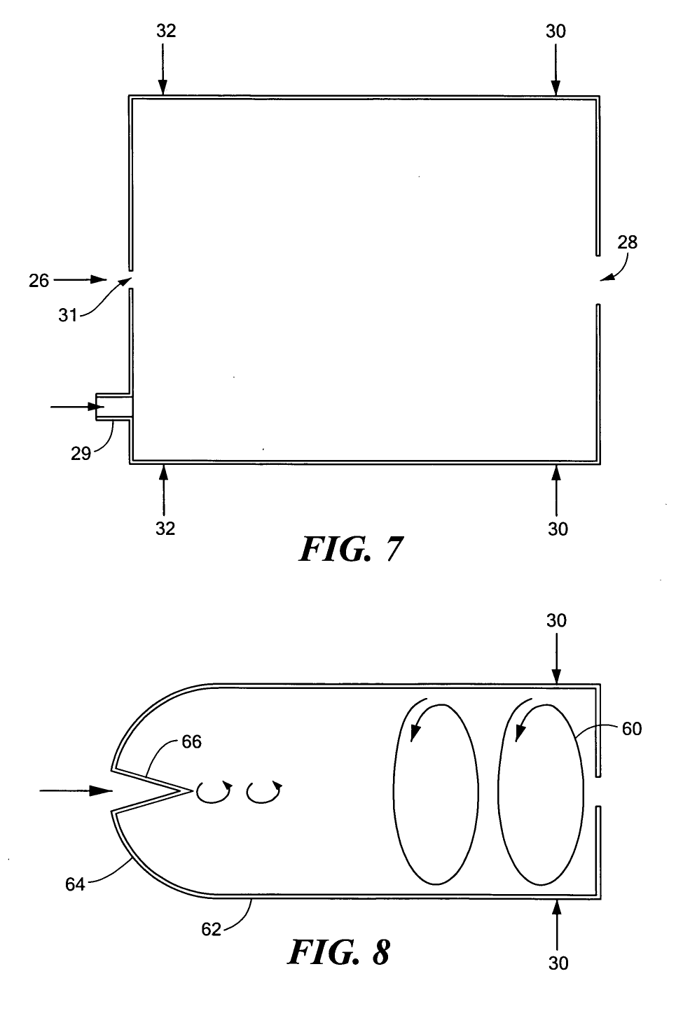

FIG. 7 illustrates another form of the combustion chamber in the shape of a cylinder. As before, the powdered fuel/air mixture (26) is injected into the chamber at the closed end (31) along the axis of the cylinder. Air is injected tangentially at point(s) (30) and/or (32) to create a reverse vortex flow from the open end (28) to the closed end (31) of the combustion chamber. The exit from the chamber may have a restricted aperture or a specially shaped nozzle.

The frustum shown in FIG. 5 can be configured to improve the operation of the combustion chamber. For example, the powdered fuel/ceramic powder mixture can be injected directly into the reverse vortex port at points (30) in the combustion chamber, thereby causing improved mixing of the air with the powder. In addition, the powdered fuel mixture will absorb radiant heat from the center of the combustion chamber thereby preheating the powdered mixture while at the same time insulating the combustion chamber walls from the heat of combustion.

If the selected fuel is silicon powder, there is an added benefit. Silicon powder is black as coal dust and acts as a perfect “black body” absorber. This will significantly improve the preheating of the fuel/air mixture and cool the walls of the combustion chamber.

If the powdered fuel mixture is injected into the reverse vortex port, then the igniter can be centered on the axis of the chamber at the closed end. Likewise, the same approach can be taken with the cylindrical combustion chamber shown in FIG. 5. In this case the powdered fuel mixture is injected into the reverse vortex port at points (30) along with the air flow to support combustion and cool the walls of the combustion chamber. In this case the igniter (29) can be placed at the center of the closed end of the combustion chamber.

FIG. 8 illustrates another important aspect of the invention, illustrated with a cylindrical combustion chamber (62) having a curved end (64) and, optionally, an inwardly extending conical portion (66). The reverse vortex air stream is illustrated as (60) and is produced by air or oxygen injected at points (30) as described. This air steam flows along the inside walls of the combustion chamber (62) with an initial rotational angular velocity. When the air stream approaches the closed end (64) of the combustion chamber, the diameter of the chamber is reduced according to the specific shape of the closed end. The velocity of the reverse vortex air stream remains basically constant and therefore the angular velocity of the air stream increases as the diameter of the chamber decreases.

The shape of the closed end also causes the vortex stream to reverse direction and travel to the open end of the chamber and in the axial center of the combustion chamber. The higher angular velocity caused by the shape of the closed end of the combustion chamber improves the mixing of the fuel/air/powder thereby improving combustion and heat transfer to the non-combustible powder. In addition, the angular rotation of the air stream increases the effective length of the combustion chamber and thus increases the dwell or residence time of the combustion chamber. The shape of the closed end of the combustion chamber can be designed to “focus” the reverse vortex spiral as it travels from the closed end to the open end of the combustion chamber. The fuel/powder mixture can be introduced at points (30) and/or at other ports into the chamber, as described above.

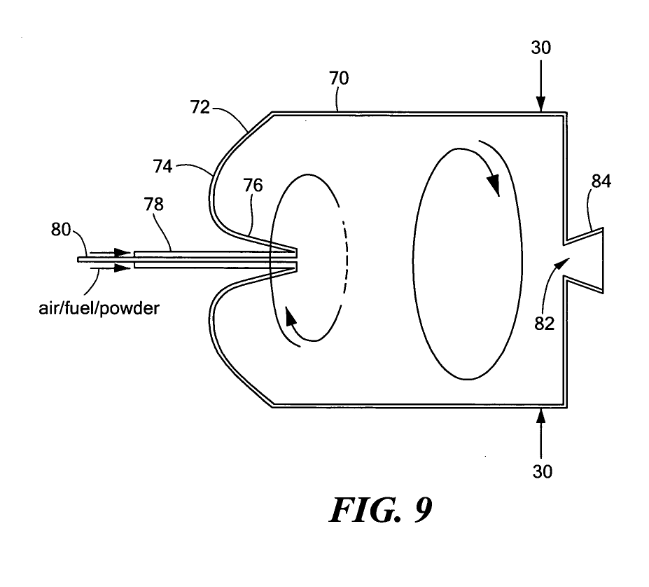

Another embodiment of a combustion chamber in accordance with the invention is shown in FIG. 9. The chamber (70) is of cylindrical shape having a conical section (72) end and a curved transitional section (74) which joins an optional inwardly extending conical portion (76). A pair of concentric pipes (78) and (80) are positioned at the closed end of the annular area of portion (76). The inner pipe (80) is part of the plasma igniter. The outer pipe (78) serves to inject air and the fuel/ceramic powder mixture into the combustion chamber. A small amount of fuel/ceramic powder may be introduced with a larger volume of air into the chamber at points (30), as in the above embodiment. The exit end of the combustion chamber has an aperture (82) which is in communication with a nozzle (84) for providing the plasma spray to a work surface. The nozzle may not be necessary for all applications. For applications not requiring a nozzle, the plasma spray emanates from the aperture (82) of the chamber.

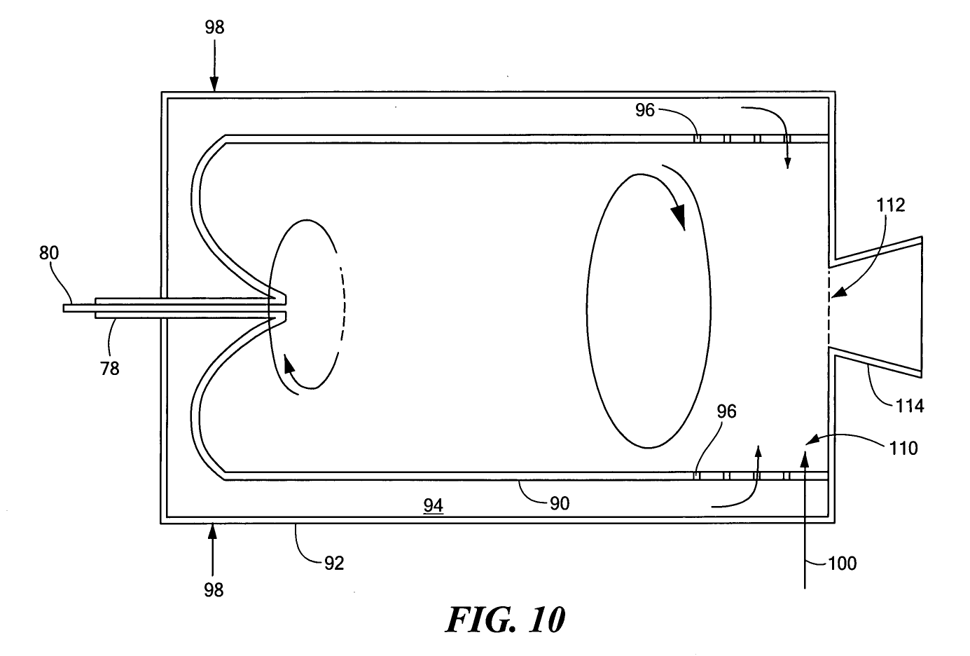

A further embodiment of a combustion chamber is shown in FIG. 10. The combustor has a cylindrically shaped ceramic inner lining (90) that has a closed end of curved configuration which terminates in an optional inwardly extending conical portion similar to that shown in FIG. 9. This closed end is shaped to change the direction of the reverse vortex. Alternatively, the closed end of the chamber may be flat. The chamber (90) is enclosed within an outer housing (92) which is typically made of steel or titanium. The space (94) between the inner ceramic chamber and outer housing is in fluid communication with the inside of the combustion chamber by means of holes or openings (96) provided through the wall of the combustion chamber near the open or exit end thereof. The openings are preferably oriented tangentially to the inside surface of the combustion chamber and directed toward the closed end of the chamber. The openings are oriented at a tangential angle of approximately 20°.

In one version of a combustion chamber shown in FIG. 10 two concentric pipes (78) and (80) are located at the closed end of the double-walled combustion chamber. As discussed in FIG. 9, the inner pipe (80) is normally configured as a high temperature plasma igniter and the larger pipe (78) serves as the entry port for the powdered fuel/ceramic powder and air/oxygen mixture. As discussed below, the igniter and entry ports can be otherwise located.

In one form of the combustion chamber the powdered fuel/air mixture is injected at one or more points (98) into the space (94) between the inner and outer housings. The air is injected tangentially to the inside wall of the outer housing (92) and results in a forward vortex of air/fuel which spirals in space (94) toward the open end of the combustor. The forward vortex cools the surface of the inner ceramic shell and thermally insulates the outer shell from the inner shell and preheats the air/fuel mixture prior to the mixture being injected into the combustion chamber at openings (96). Since the space (94) is sealed, pressure builds up in this space and forces the air/fuel mixture through the openings (96) and into the combustion chamber. The orientation of the openings causes a reverse vortex to be formed on the inside of the combustion chamber which flows in a spiral manner from the open end towards the closed end of the chamber.

A plasma igniter (100) extends through the outer housing and wall of the inner vessel into the exit portion of the combustion chamber, as illustrated. The igniter directs its ignition plasma tangentially to the wall of the combustion chamber and pointed slightly toward the closed end of the chamber. The igniter causes the fuel/air mixture to ignite approximately at point (110) and the flame to propagate in a reverse vortex manner toward the closed end of the combustion chamber. As described above, the closed end of the combustion chamber is preferably shaped to reverse the direction of the burning reverse vortex and increase the tangential velocity of the resulting vortex which propagates forwardly toward the open end of the chamber.

The result of the fuel/air mixture burning during the traversal of the reverse vortex in the chamber and the continued burning of the mixture in the forward propagation of the vortex increases the time that burning occurs inside the combustion chamber. This residence time is an important factor in causing the fuel to burn completely and to transfer the maximum amount of heat energy to the non-combustible ceramic powders mixed with the combustible metallic powders. The exit aperture (112) of the combustion chamber may be significantly smaller than the inside diameter of the chamber. This choked chamber serves to increase the residence time of the burning mixture in the combustion chamber, to increase the pressure in the combustion chamber and to increase the velocity of the exhaust from the combustion chamber. The exhaust speed of the molten ceramic particles is very important in achieving the intended adhesion of the particles on the surface to be coated. Optionally, an exhaust nozzle (114) may be attached to the output of the combustion chamber.

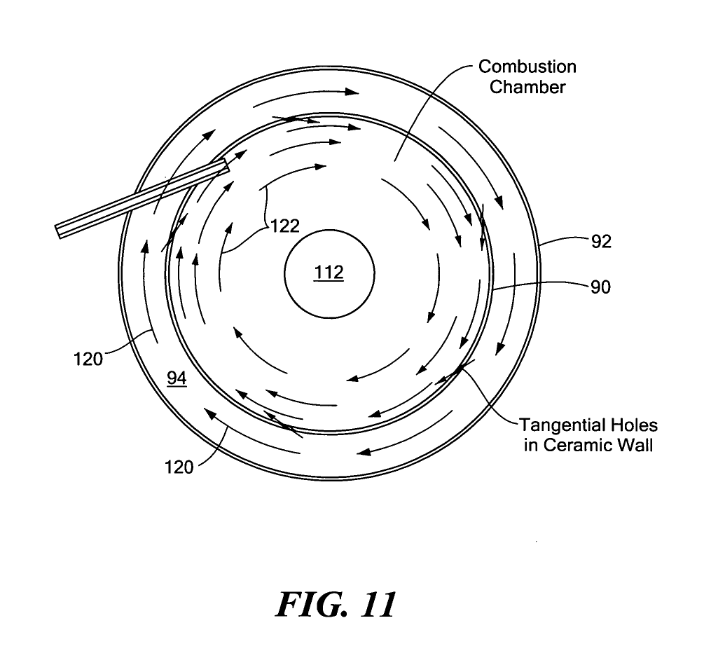

FIG. 11 illustrates a cross-sectional view of the embodiment of FIG. 10. Arrows (120) illustrate the rotational and spiral flow of the air/fuel mixture in the space (94) toward the open end of the combustion chamber. As the only exit from the space (94) is through openings (96) in the combustion chamber wall, the fuel/air mixture is forced through these openings in a tangential manner and onto the inner surface of the combustion chamber. The reverse vortex formed inside the chamber is ignited by the plasma igniter as described above and results in a burning reverse vortex flame propagation pattern illustrated by arrows (122).

In another form of the combustion chamber only a portion of the powdered fuel/air mixture is injected at one or more points (98) into the space (94) between the inner and outer housings. The powdered fuel-air mixture is configured to be a lean mixture which is not sufficient to maintain combustion. This mixture is injected tangentially to the inside wall of the outer housing (92) and results in a forward vortex of air/fuel which spirals in space (94) toward the open end of the combustor. The forward vortex cools the surface of the inner ceramic shell and thermally insulates the outer shell from the inner shell and preheats the air/fuel mixture prior to the mixture being injected into the combustion chamber at openings (96). Since the space (94) is sealed, pressure builds up in this space and forces the air/fuel mixture through the openings (96) and into the combustion chamber. The orientation of the openings causes a reverse vortex to be formed on the inside of the combustion chamber which flows in a spiral manner from the open end towards the closed end of the chamber.

In this case the igniter is typically placed on the central axis of the combustion chamber and at the closed end as indicated by the pipe (80). The majority of the powdered fuel/ceramic powder air/oxygen mixture is projected into the combustion chamber via pipe (78) located at the closed end of the combustion chamber. When mixed with the lean mixture from the reverse vortex the resulting fuel/air mixture now sustains combustion.

Typically, the combustion chamber is formed as a molded or machined ceramic vessel, which can be a single replaceable unit. A typical ceramic material is aluminum oxide which has a melting point of 3762° F. Since the typical combustible metallic fuel is silicon and the typical non-combustible material is silicon dioxide, the combustion chamber is designed to operate at a temperature of about 3110° F. which is the melting temperature of silicon dioxide.

The outer housing is typically made from steel or titanium and this housing is isolated from the extreme temperatures on the inside of the ceramic combustion chamber by the forward vortex of air and powdered fuel which is caused to flow between the inner and outer shells.

In the embodiments of the combustion chamber described herein, it will be appreciated that air or oxygen can be introduced into the chamber at one or more different positions, and that fuel and/or powder can also be introduced into the chamber at one or more positions, separate from or together with the air/oxygen. The igniter can also be variously located to ignite the mixture in the chamber.

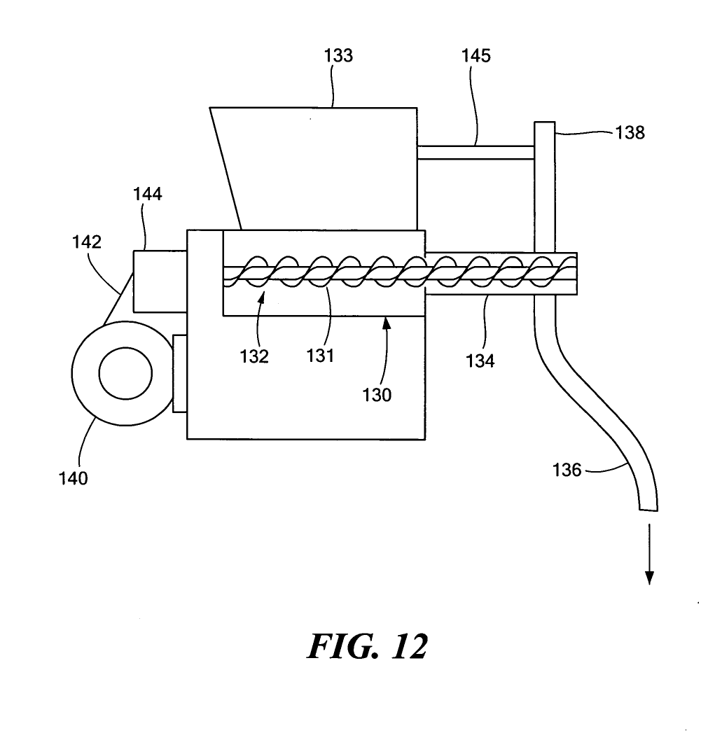

FIG. 12 shows a powder feeder. The feeder includes a screw conveyer (130) having a trough (131) and screw feeder (132) which conveys the combustible and non-combustible powders contained in a hopper (133) or other container through a feeder tube (134) to a pipe or hose (136) which serves as a supply line to the combustion chamber. The pipe or hose (136) may be flexible or rigid depending on the particular installation. Air or oxygen is injected into tube (138) for mixing with the fuel/ceramic powder provided by the screw conveyer. Tube (138) may be in fluid communication with the hopper (133) via tube (145). In this case the hopper (133) will have be sealed from the normal atmospheric pressure by a cover. The tube (145) serves to equalize the pressure at both ends of the screw feeder (132) and prevent the powder from being driven backward through the feeder tube (134) to the hopper (133). The ratio of air/oxygen to the fuel/ceramic powder can be independently controlled to provide precise mixing of an intended amount of air/oxygen and fuel/powder. An electric motor (140) drives the screw conveyer via a pulley and belt assembly (142) and speed reducer (144). Other motive means can be utilized in alternative implementations.

The invention is not to be limited by what has been particularly shown and described and is to embrace the full spirit and scope of the appended claims.

What is claimed is:

1. A process for forming a coherent refractory mass on the surface of a road comprising the steps of:
providing a road marking composition comprising one or more non-combustible dry powders and one or more metallic combustible powders and an oxidizer;
transporting the composition to a combustion chamber;
igniting the mixture in the combustion chamber so that the majority of the combustible particles react in an exothermic manner with the oxidizer inside of the combustion chamber and release sufficient heat to form a high temperature coherent refractory mass under the action of the heat of combustion;
projecting said high temperature heated mass from the combustion chamber onto the surface of the road so that the mass adheres durably to the surface of the road; and
permitting the mass to cool sufficiently for it to solidify on the surface of the road.

2. The process of claim 1 wherein the non-combustible powders are selected from the group consisting of silicon dioxide, titanium dioxide, aluminum oxide, iron oxide, calcium oxide and sodium carbonate or a mixture of two or more thereof; and
wherein the combustible powders are selected from the group consisting of silicon, aluminum and iron, or a mixture of two or more thereof.

3. The process of claim 2 wherein the calcium oxide and sodium carbonate react with the silicon dioxide to form soda-lime glass.

4. The process of claim 2 wherein the non-combustible powders are silicon dioxide, calcium oxide and sodium carbonate, and wherein the combustible powder is iron.

5. The process of claim 1 wherein the oxidizer is air or oxygen.

6. The process of claim 4 wherein the mixture, when ignited in the combustion chamber with the oxidizer so that the iron reacts in an exothermic manner with the oxidizer, releases sufficient heat to form Fe₂O₃ (yellow iron oxide), Na₂SiO₅ (soda-lime glass), SiO₂ (silicon dioxide), and either Ca₂SiO₄ or CaSiO₃.

7. The process of claim 4 wherein the combustion flame temperature is sufficient to melt soda-lime glass (Na₂SiO₅) but is insufficient to melt silicon dioxide (SiO₂).

8. The process in claim 7 wherein the resulting refractory mass consists of a slurry of Na₂SiO₅ (soda-lime glass) as a liquid, Fe₂O₃ in crystalline form, SiO₂ in crystalline form and either Ca₂SiO₄ or CaSiO₃ in crystalline form.

9. The process of claim 2 wherein the non-combustible powders are silicon dioxide (SiO₂), sodium carbonate (Na₂CO₃), calcium oxide (CaO) and titanium dioxide (TiO₂) and the combustible powder is silicon (Si).

10. The process of claim 9 wherein the mixture, when ignited in a combustion chamber with the oxidizer so that the silicon reacts in an exothermic manner with the oxidizer, releases sufficient heat to form a refractory mass consisting of soda lime glass (Na₂SiO₅) as a liquid and silicon dioxide (SiO₂) and titanium dioxide (TiO₂) in crystalline form.

11. The process of claim 9 wherein a small amount of aluminum (Al) is added to facilitate the ignition of the mixture.

12. The composition of claim 4 wherein a small amount of aluminum (Al) is added to facilitate the ignition of the mixture.
